(19) United States
(12) Patent Application Publication
(10) Pub. No.: US 2024/0311916 A1
(43) Pub. Date: Sep. 19, 2024

(54) COMPUTATIONALLY-EFFICIENT RECOMMENDATION GENERATION SYSTEM

(71) Applicant: TD AMERITRADE IP COMPANY, INC., Omaha, NE (US)

(72) Inventors: Harrison W. NAPPER, Naperville, IL (US); Chris Raymond JENNINGS, Omaha, NE (US)

(73) Assignee: Charles Schwab & Co., Inc, San Francisco, CA (US)

(21) Appl. No.: 18/551,024

(22) PCT Filed: Sep. 28, 2020
(86) PCT No.: PCT/US2020/053124

§ 371 Date: Sep. 18, 2023

(51) Int. Cl. G06Q 40/06; G06Q 40/04

(52) U.S. Cl. CPC G06Q 40/06; G06Q 40/04

(57) ABSTRACT

A system includes a processor and a memory. The memory stores a parameter database including parameters for entities and instructions for execution by the processor. The instructions include, in response to receiving a request control signal including a scaling factor from a user device, obtaining a set of actions and a corresponding equivalence value for each action from the parameter database. The instructions include filtering the set of actions based on the corresponding equivalence value of the set of actions. The instructions include, for each action of the filtered set of actions, obtaining a set of parameters from the parameter database, computing a recommendation factor based on the set of parameters, and adding the corresponding action to a recommendation list in response to the recommendation factor being less than a threshold. The instructions include transforming an interface of the user device by rendering a graphical depiction of the recommendation list.

### FIELD

The present disclosure relates to systems and methods for computerized display and realization of requested leverage factors and more particularly to systems and methods for efficiently identifying rebalancing recommendations.

### BACKGROUND

During volatile market conditions, many traders and investors employ capital. Once all capital is employed, it becomes unclear to many users how to implement further strategies to improve their position. A user could scale down and scale up existing positions or investments, but even scaling is limited because the user needs to increase capital allocation in order to get increased exposure.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes at least one processor and a memory coupled to the at least one processor. The memory stores a parameter database including a set of parameters for entities and instructions for execution by the at least one processor. The instructions include, in response to receiving a request control signal including a scaling factor from a user device, obtaining a set of actions and a corresponding equivalence value for each action from the parameter database. The instructions include filtering the set of actions based on the corresponding equivalence value of the set of actions. The instructions include, for each action of the filtered set of actions, obtaining a set of parameters from the parameter database, computing a recommendation factor based on the set of parameters, and adding the corresponding action to a recommendation list in response to the recommendation factor being less than a threshold. The instructions include transforming an interface of the user device by rendering a graphical depiction of the recommendation list.

In other features, the instructions include, for each action of the recommendation list, computing an action scaling factor and displaying the action scaling factor in the recommendation list. In other features, the action scaling factor is based on at least one of: (i) a change value, (ii) a parameter of a corresponding entity, and (iii) an amount of the action. In other features, the parameter of the corresponding entity corresponds to time-series data associated with the corresponding entity.

In other features, the instructions include, for each action of the recommendation list, calculating a difference between the corresponding action scaling factor and the scaling factor and displaying the corresponding difference in the recommendation list. In other features, the instructions include sorting the recommendation list based on the difference.

In other features, the corresponding equivalence value is a delta value indicating a value of the corresponding action compared to a value of an entity. In other features, the entity is associated with the corresponding action. In other features, filtering the set of actions includes removing a first action from the set of actions when the corresponding equivalence value is negative and the scaling factor is positive.

In other features, filtering the set of actions includes removing a first action from the set of actions when the corresponding equivalence value is positive and the scaling factor is negative. In other features, the request control signal includes an asset identifier. In other features, obtaining the set of actions includes obtaining each action associated with the asset identifier. In other features, the instructions include determining an output to realize the scaling factor and filtering the set of actions based on the output to realize the scaling factor.

In other features, the request control signal includes the output to realize the scaling factor. In other features, the memory stores a user parameter database including account information of a user operating the user device. In other features, determining the output includes obtaining the account information of the user, identifying the output based on the account information, and excluding account information including an association with an entity.

A method includes, in response to receiving a request control signal including a scaling factor from a user device, obtaining a set of actions and a corresponding equivalence value for each action from a parameter database. The parameter database including a set of parameters for entities. The method includes filtering the set of actions based on the corresponding equivalence value of the set of actions. The method includes, for each action of the filtered set of actions, obtaining a set of parameters from the parameter database, computing a recommendation factor based on the set of parameters, and adding the corresponding action to a recommendation list in response to the recommendation factor being less than a threshold. The method includes transforming an interface of the user device by rendering a graphical depiction of the recommendation list.

In other features, the method includes, for each action of the recommendation list, computing an action scaling factor and displaying the action scaling factor in the recommendation list. In other features, the action scaling factor is based on at least one of: (i) a change value, (ii) a parameter of a corresponding entity, and (iii) an amount of the action. In other features, the parameter of the corresponding entity corresponds to time-series data associated with the corresponding entity.

In other features, the method includes, for each action of the recommendation list, calculating a difference between the corresponding action scaling factor and the scaling factor and displaying the corresponding difference in the recommendation list. In other features, the method includes sorting the recommendation list based on the difference.

In other features, the corresponding equivalence value is a delta value indicating a value of the corresponding action compared to a value of an entity. In other features, the entity is associated with the corresponding action.

In other features, filtering the set of actions includes removing a first action from the set of actions when the corresponding equivalence value is negative and the scaling factor is positive. In other features, filtering the set of actions includes removing a first action from the set of actions when the corresponding equivalence value is positive and the scaling factor is negative.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level example block diagram of a recommendation generation system.

FIGS. 2A-2B are representations of example user interfaces for recommendation generation and display.

FIG. 3 is a representation of an example user interface presenting a table of generated recommendations.

FIGS. 4A-4B are representations of example user interfaces for receiving a leverage request from a user.

FIG. 5 is a functional block diagram of an example recommendation generation module.

FIG. 6 is a flowchart depicting example generation of a recommendation list.

In the drawings, reference numbers may be reused to identify similar and/or identical elements.

### DETAILED DESCRIPTION

A recommendation generation system receives a leverage request from a user and generates recommendations for the user that would result in the user's portfolio realizing a leverage factor included in the leverage request. The user can submit the leverage request through a user device, such as a phone, tablet, computer, etc. The leverage request indicates a desired leverage factor that the user would like their account or portfolio to realize. For example, the user's account includes financial instruments-such as stocks, options, etc.—that the user holds through a financial institution. The financial instruments may be defined as entities that are dependent time-series data. The user may log in to a website operated by the financial institution to access their account and portfolio, including their financial instruments.

For each financial instrument in the user's portfolio or for a potential purchase of a financial instrument, the user may have a desired leverage factor or risk factor the user would like to realize. This leverage factor generally indicates to the user how sensitive the particular financial instrument is to the market compared to the average user or investor. The user may consider the leverage factor of an individual financial instrument or a leverage factor of the user's portfolio.

As an example, if the leverage factor of a user's portfolio is 3.4, then the user's investments are 3.4 times more market sensitive than the average user. Therefore, if the underlying instruments of the user's investments increase by 1%, then the user's portfolio will increase by 3.4%. At the same time, if the underlying instruments of the user's investments decrease by 1%, then the user's portfolio will decrease by 3.4%.

The recommendation generation system allows users to maintain their capital allocation while increasing their sensitivity to the movement in a particular security or the market as a whole. For instance, if all of a user's capital in their portfolio is deployed and the market is down big because of some large event, the user may increase the bullishness of their portfolio and recover faster using a smaller recovery amount. In various implementations, a user can create a portfolio using the recommendation generation system. For example, the user can indicate a target leverage factor, an amount of capital, and underlying securities in which the user would like to invest. Additionally or alternatively, the user could individually select a leverage factor for selected underlying securities based on how well the user anticipates the particular security is going to perform.

Based on the user indicating their desired leverage factor, the recommendation generation system can identify financial instruments that match or near the indicated leverage factor. To identify which financial instruments are near the indicated leverage factor, the recommendation generation system determines a set of financial instruments from which the user may select. In various implementations, the set of financial instruments may be reduced or limited based on the present investments of the user. For example, the user may indicate to the recommendation generation system to only identify derivatives of the user's present investments; therefore, if the user is only presently invested in stock A and stock B, the recommendation generation system only obtains as the set of financial instruments the derivatives of stock A and stock B, such as options, futures contracts, swaps, etc. based on stock A and stock B.

Based on the determined or obtained set of financial instruments, the recommendation generation system excludes certain financial instruments based on a corresponding delta value and the indicated leverage factor. For example, the recommendation generation system can remove financial instruments with a negative delta if the user inputs a positive leverage factor, indicating that the user is expecting the market to increase or a bullish market.

Similarly, if the user inputs a negative leverage factor, predicting a decrease in the market or a bearish market, the recommendation generation system can exclude all positive deltas. Additionally, since deltas can indicate whether the financial instrument is a buy/call, sell/call, buy/put, sell/put, the recommendation generation system can further exclude deltas below or above 0.5 (same for −0.5). By reducing the number of financial instruments analyzed throughout the generation of the recommendation list, the recommendation generation system reduces the number of calculations performed, increasing computational efficiency and reducing user wait time for the recommendation list.

In various implementations, the recommendation generation system can further remove financial instruments based on a buying power effect, a present price, etc. For example, the user may indicate an amount of capital the user has available to invest. Alternatively, the recommendation generation system may determine, based on the user account parameters, the amount the user has available to invest. In various implementations, the recommendation generation system may further implement a rebalancing approach to achieve the input leverage factor for the user's portfolio. That is, based on the leverage factor of the user's portfolio and the input or desired leverage factor of the user, the recommendation generation system can generate a recommendation for selling part of the user's portfolio to invest in a recommended financial instrument to realize the input leverage factor.

With the remaining set of financial instruments, the recommendation generation system calculates a liquidity factor. The liquidity factor may be determined at various points within the recommendation generation system to optimize the calculation, improving performance. The liquidity factor indicates whether the user would be recommended to perform the trade (purchase or sale) for each of the remaining set of financial instruments. That is, based on whether a range between the bid and ask is large (meaning you might lose a notable amount of investment), trading volume or open interest is low (meaning not many users are interested in trading this option or financial instrument), etc.

The liquidity factor of the remaining set of financial instruments is calculated based on a set of parameters corresponding to each financial instrument. The set of parameters for the financial instruments can be obtained from a database, such as a stock and derivative parameter database. The set of parameters to calculate the liquidity factor of a financial instrument may include: (i) a bid and ask range, (ii) the bid, (iii) the ask, (iv) a depth, (v) a mark or midpoint, (vi) a contract multiplier, (vii) an open interest, (viii) a volume, etc. . . . In various implementations, additional or fewer parameters may be used to determine the liquidity factor.

Based on the set of parameters, a lower liquidity factor indicates a more reasonable trade of a financial instrument. Therefore, the recommendation generation system filters out financial instruments with a liquidity factor above a threshold. For example, the recommendation generation system may filter out those financial instruments with a liquidity factor above 0.4. In various implementations, the recommendation generation system may graph the liquidity factors and identify a point at which the liquidity factor exponentially increases (for example, identifying when a slope begins to significantly increase). The recommendation generation system may then filter out those financial instruments with liquidity factors above the point of inflection or significant slope increase.

The recommendation generation system may transmit and display a list of the remaining financial instruments, ordered by a beta-weighted leverage factor of the financial instrument. For example, the recommendation generation system can compute the leverage factor of a trade based on the corresponding delta, the price of the underlying security, and the mark price of the financial instrument (option).

In various implementations, the recommendation generation system can determine a difference between the input leverage factor and the computed leverage factor of the financial instrument to indicate a closeness of the financial instrument to the input leverage factor. Further, the recommendation generation system may vary a trade quantity of the financial instrument in a situation where the difference is greater than a closeness threshold.

In various implementations, the recommendation generation system can automatically generate a recommendation list to maintain the user's portfolio with a leverage factor threshold. The user may set up their account to automatically generate recommendations to rebalance their portfolio near the user input leverage factor and only recommending stocks or derivatives for particular securities. In various implementations, the user may be a broker managing a plurality of accounts or an individual managing their personal account.

The recommendation generation system may provide users with the opportunity to adjust their exposure (and potential gains) without needing to increase a total amount invested. Using derivatives is one method to adjust exposure without investing additional money. To provide a simple method of performing derivative investments in a user friendly way, the recommendation generation system provides users with a recommendation list based on a leverage factor or risk factor. Further, incorporating derivatives allows users the opportunity to continue to invest in their favored stocks, but in different ways. As an example, if the user anticipates that the stock market or a particular stock is going to perform extremely well, the user can increase their leverage factor, allowing the user to perform factors better than the underlying stock if the user prediction is realized. That is, if the user increases their leverage factor to 5 for stock XYZ, when stock XYZ value increases 1%, the user value increases 5%. The user can implement the leverage factor change by adding capital to a particular financial instrument or rebalancing present investments.

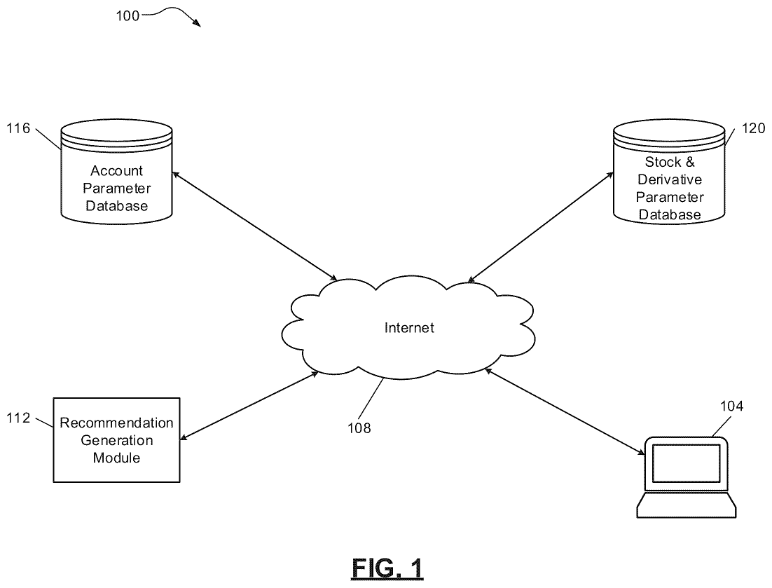

FIG. 1 is a high-level example block diagram of a recommendation generation system 100. A user device 104 of the recommendation generation system 100 interacts via the Internet 108 with a recommendation generation module 112. The recommendation generation module 112 receives user input from the user device 104 via the Internet 108. The user input includes a leverage request indicating a leverage factor. In various implementations, the leverage request may include an amount input by the user as well as a particular stock the user requests to limit the recommendation list to trades associated with the particular stock.

To generate a recommendation list, the recommendation generation module 112 obtains data stored in an account parameter database 116 and a stock and derivative parameter database 120. Based on the obtained data, the recommendation generation module 112 identifies stocks and derivatives that are near or at the user's input leverage factor. Further, the recommendation generation module 112 excludes stocks or derivatives that are less frequently traded or that have a higher liquidity factor or ratio. In various implementations, the user device 104 may be a mobile computing device, such as a phone, tablet, laptop, etc, or other computing device such as a computer. The user may be an associate employed by a financial institution that manages financial accounts for a variety of clients or users. The user may also be an individual who is managing their own account with a financial institution.

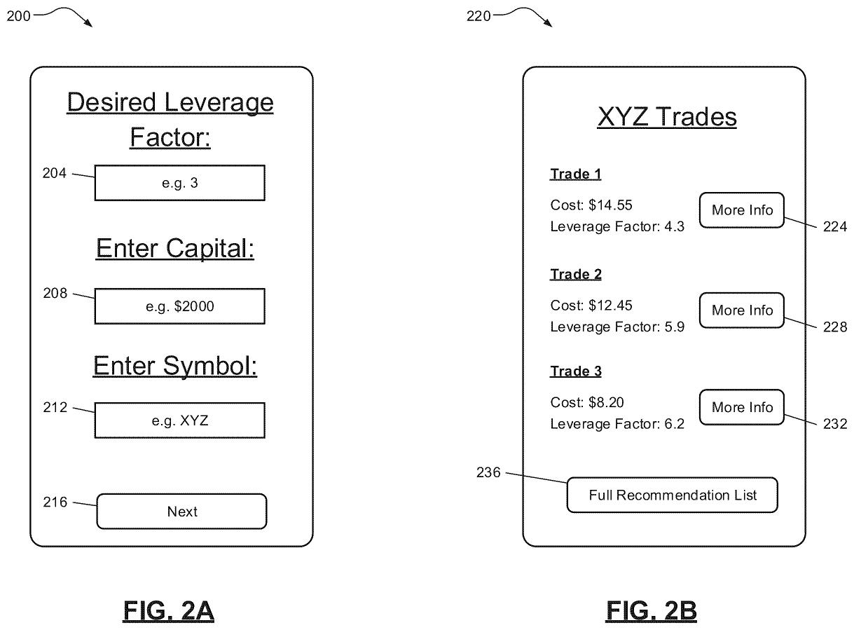

FIGS. 2A-2B are representations of example user interfaces for recommendation generation and display. In an example, the user may log on to their financial account associated with the financial institution and navigate to a leverage factor interface 200, shown in FIG. 2A. In various implementations, an icon or section on a login homepage may include a link to the leverage factor interface 200 that implements the recommendation generation system. The icon or section may advertise a present leverage factor of the user's present financial instruments, as a whole or individually.

Once the user navigates to the leverage factor interface 200, multiple user-fillable fields are presented to the user. A desired leverage factor field 204, a capital field 208, and a symbol field 212 may be filled by the user. In various implementations, the fields 204, 208, and 212 may be drop-down menus or other methods of inputting the requested parameters. In various implementations, the user is requested to input at least one of the fields 204, 208, 212 but may opt to leave all fields 204, 208, 212 empty. For example, if the user only inputs a desired leverage factor, the recommendation generation system may use a default amount of capital and identify trades corresponding to any stock and derivative. Additionally or alternatively, the recommendation generation system may obtain an amount of capital available according to the user's account information stored in the account parameter database 116 of FIG. 1. Similarly, in various implementations, the recommendation generation system may identify which symbols the user is presently invested in and limit the recommendations to those identified stocks and corresponding derivatives.

In various implementations, if the user excludes the desired leverage factor, the recommendation generation system may select the leverage factor as the leverage factor of the user's portfolio. Once the user completes as many fields as desired, the user selects a next button 216 to continue to a recommendation list interface 220 of FIG. 2B.

The recommendation list interface 220 lists a set of trades (financial instruments), in this example, corresponding to the XYZ symbol. Each trade listed may include a cost and a corresponding leverage factor. In various implementations, additional details for each trade may be depicted, including a liquidity factor, a difference or closeness to an input leverage factor, etc.

A first more info button 224 corresponds to a first trade, a second more info button 228 corresponds to a second trade, and a third more info button 232 corresponds to a third trade. If selected, the first more info button 224 navigates the user to a webpage including full details about the first trade. The second more info button 228 and the third more info button 232 similarly navigate the user to a webpage including details about the corresponding trade. In various implementations, the recommendation list interface 220 may include a complete trade button to allow the user to implement the recommended trade.

The user may also select a full recommendation list button 236 to navigate the user to a complete recommendation list with additional trades. In various implementations, the recommendation list interface 220 may include more or fewer trades.

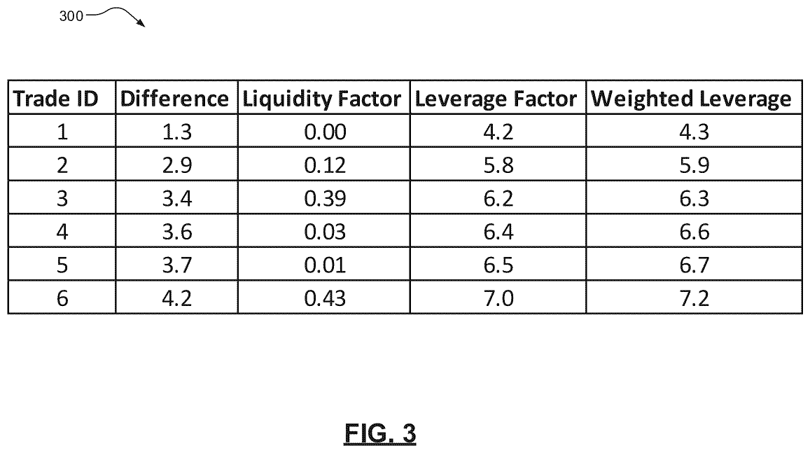

FIG. 3 is a representation of an example user interface presenting a table 300 of generated recommendations. The table 300 includes a list of trade IDs and corresponding information about each trade for a requested leverage factor of 3 for a symbol with a beta-weight of 1.2. The beta-weight of the symbol is used to standardize the leverage factor based on the symbol's comparison to an index, such as the S&P. In an example where the recommendation generation system includes a plurality of symbols, the table 300 may also include a column identifying the symbol corresponding to the trade.

The table 300 may also include columns for a difference, a liquidity factor, a leverage factor, and a weighted leverage factor. The difference indicates how close the weighted leverage factor is to the input or requested leverage factor. For example, the table 300 was generated for a requested leverage factor of 3. Therefore, the difference between the requested leverage factor and the weighted leverage factor of the first trade is 1.3.

The liquidity factor for each trade is calculated based on a set of parameters including: (i) a bid, (ii) an ask, (iii) a mark. (iv) a contract multiplier, (v) an open interest, and (vi) a volume. The mark or midpoint is the midpoint price between the bid and the ask. The contract multiplier is a number of contracts the user would have to purchase to implement the trade. The volume is a number of times users have performed the corresponding trade on this day or within a threshold number of days (depending on how many days until expiration). The open interest is a number of outstanding contracts for the corresponding trade. Each of these parameters can be obtained from a database, such as the stock and derivative parameter database 120 of FIG. 1. The liquidity factor (LF) may be calculated according to the following equation:

$$LF = \frac{\frac{\frac{( \frac{bid - ask}{mark} )}{( multiplier * 100 )}}{( interest + \text{.01} )}}{( volume + \text{.01} )} * 1000$$

The liquidity factor indicates how frequently (or infrequently) the trade is performed compare to other trades available. Therefore, the recommendation generation system identifies those trades that are more frequently performed and those with a smaller bid-ask spread (difference between bid and ask) to further identify trades that appear more preferable. That is, a trade with a smaller bid-ask spread may be more ideal because less investment is immediately potentially lost upon purchase (for example, with a bid-ask spread of $13, the user is immediately at risk to lose $13 upon purchase where a trade with a bid-ask spread of $5 presents the user with an immediate potential loss of $5 upon purchase). The liquidity factor calculation is based on present bid and ask prices; however, in various implementations, the liquidity factor calculation may use bid and ask prices over a threshold time range.

The leverage factor for each trade is also calculated and included in the table 300. For example, the leverage factor for a trade can be calculated using (i) a delta of the trade, (ii) a price of the underlying security or symbol, and (iii) an ask or price of the trade. More specifically, the leverage factor of a trade can be determined according to the following equation:

$$Leverage = \frac{( delta ) * ( price of security )}{ask}$$

By multiplying the leverage factor and the beta-weight of the underlying security, the weighted leverage factor is calculated. In various implementations, user-selectable buttons may be included in the table to allow the user to complete the trade upon selection. In various implementations, the table 300 may be displayed in response to the user selecting the full recommendation list button 236 of FIG. 2B.

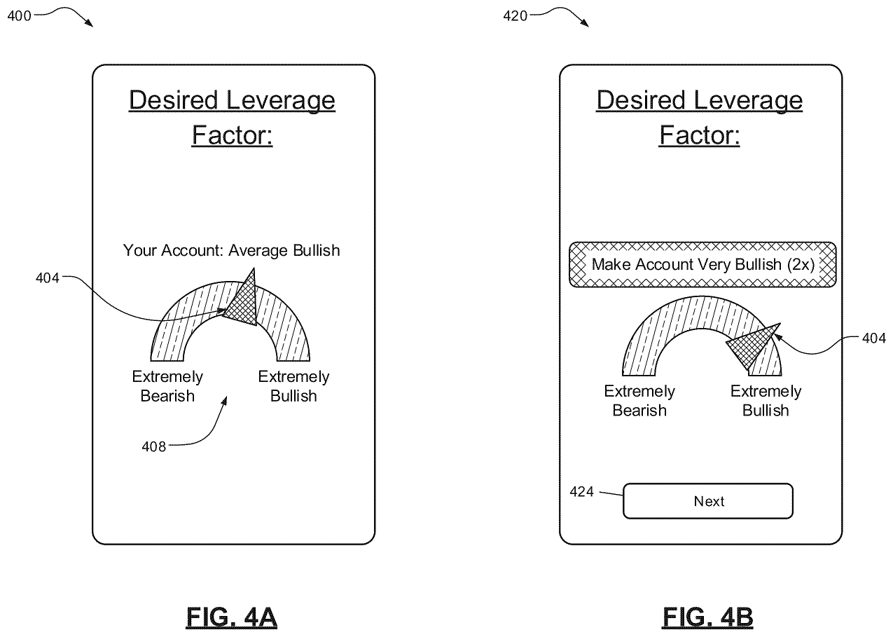

FIGS. 4A-4B are representations of example user interfaces for receiving a leverage request from a user. FIG. 4A depicts a leverage factor request interface 400 including a moveable user interface element 404 for the user to input a desired leverage factor. For example, the user may navigate to the leverage factor request interface 400 to check the leverage factor of their portfolio. In various implementations, the leverage factor request interface 400 may include a separate leverage factor for each financial instrument in the user's portfolio.

As shown in the leverage factor request interface 400, the display indicates that the user's portfolio or account is “average bullish,” informing the user that the user's investments are similar to other users who anticipate the stock market will generally increase. The leverage factor request interface 400 depicts an array 408 ranging from extremely bearish (anticipating the stock market will decrease) to extremely bullish. The user may select and slide the moveable user interface element 404 to adjust the leverage factor of their portfolio. In an implementation where the leverage factor request interface 400 includes multiple arrays corresponding to each financial instrument, the user may adjust the individual financial instruments.

In various implementations, the recommendation generation system can generate a recommendation list within the symbol of the individual financial investment to realize the adjusted leverage factor. Further, the recommendation generation system can recommend a change in amount of investment to adjust the leverage factor of an individual investment.

In various implementations, when the user indicates that they would like to adjust the overall leverage factor of their portfolio, the recommendation generation system can rebalance the present investments to avoid the need for additional capital. However, as is described throughout the present disclosure, the recommendation generation system can determine an amount of capital available and realize the leverage factor the user is requesting using the amount.

In an example, if a user's portfolio includes $2000 invested with a leverage factor of 1 and the user adjusts their leverage factor to a 2 but the user does not have additional capital, the recommendation generation system may recommend removing $1000 from the present investments and investing the $1000 in an investment with a leverage factor of 3. Otherwise, the recommendation generation system could also recommend placing the entire $2,000 into an investment with a leverage factor of 2. Using the same example but when the user has an additional $2,000 to invest, the recommendation generation system may simply recommend investing the $2,000 in an investment with a leverage factor of 3 to obtain an average leverage factor of 2.

FIG. 4B depicts an adjusted leverage factor interface 420, as described above, after the user slides the moveable user interface element 404. The adjusted leverage factor interface 420 then indicates to the user that the adjustment would result in making the user's portfolio or account “very bullish”—about two times the average investor. The user may then select a next button 424 to generate a recommendation list based on the adjusted leverage factor.

In various implementations, the recommendation generation system may set up, for each user, automated recommendation list generation to provide the user with the ability to maintain their leverage within a certain leverage range. For example, the user could input a leverage factor with a threshold, such at 2 with a threshold of 0.1, instructing the recommendation generation system to maintain a leverage factor between 1.9 and 2.1. The user can also provide a list of favored symbols for investment. Then, the recommendation generation system can compute the user's leverage factor (for the portfolio or a portion of the portfolio) in real time or at set intervals (such as daily) and, if the leverage factor deviates from the instructed range, the user may be alerted that their portfolio is out of the user's desired range. Further, the alert may include a recommendation list of trades the user can implement to rebalance the user's portfolio.

In various implementations, the user may instruct the recommendation generation system to alert the user if their portfolio's performance is deviating from a selected symbol. For example, the user may set up their portfolio to perform two times as well as stock XYZ. Therefore, the recommendation generation system would alert the user when the leverage factor of the user's portfolio deviates from two times the leverage factor of stock XYZ. As mentioned above, the alert can include a recommendation list to rebalance the user's portfolio.

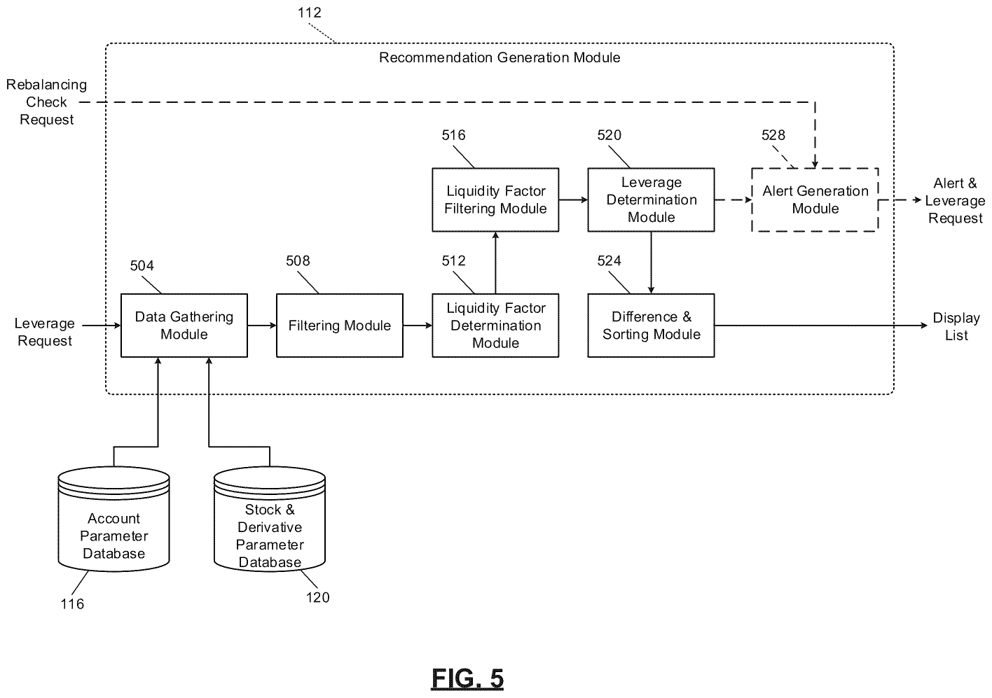

FIG. 5 is a functional block diagram of an example recommendation generation module. The recommendation generation module 112 receives a leverage request from the user via a user device. As described above, the leverage request may include: (i) a leverage factor, (ii) an amount of capital, and/or (iii) a symbol. The recommendation generation module 112 includes a data gathering module 504 that receives the leverage request. Based on the information included in the leverage request, the data gathering module 504 obtains the additional information used by the recommendation generation module 112 to generate a recommendation list.

For example, if the leverage request includes only a leverage factor, the data gathering module 504 may obtain, from the account parameter database 116, a portfolio corresponding to the requesting user. In various implementations, if the requesting user is a third party account manager, the leverage request would include identifying information of a particular portfolio. From the obtained portfolio, the data gathering module 504 can identify available funds for investing as well as symbols included in investments of the portfolio. In various implementations, the data gathering module 504 may have a default investment amount, a default set of symbols, and/or a default leverage factor. Further, if the leverage request excludes the leverage factor, the data gathering module 504 may instead use the leverage factor of the user's portfolio or a default leverage factor.

The data gathering module 504 also obtains a set of parameters used to generate the recommendation list, including a set of trades based on the symbol included in the leverage request, the symbols of the user's portfolio, or all available trades. The data gathering module 504 further obtains a set of parameters for each trade including: (i) a bid, (ii) an ask or a price of the trade, (iii) a mark, (iv) a contract multiplier, (v) an open interest, (vi) a volume, (vii) a delta, and (viii) an underlying symbol price.

The data gathering module 504 forwards the leverage request and the gathered data to a filtering module 508. The filtering module 508 removes trades of the set of trades based on a delta value. As described above, the delta of a trade may indicate whether the trade is a call or put and, similarly, whether the trade should be paired with a bullish investor or a bearish investor. Therefore, based on the leverage factor, the filtering module 508 will, for example, remove all negative deltas from the set of trades when the leverage factor is above zero, indicating that the user anticipates the market will increase.

Additionally or alternatively, the filtering module 508 can further remove trades based on the value of the delta. Using the example above, the filtering module 508 may filter out delta values below 0.5, only including delta values between 0.5 and 1 to select trades that are more likely to be in the money when the user has selected a positive, bullish leverage factor. In various implementations, the filtering module 508 may also filter the set of trades based on ask or price of the trade and/or buying power effect (the impact the trade would have on the user's buying power).

Once filtered, the set of trades, leverage request, and gathered data corresponding to the set of trades are forwarded to a liquidity factor determination module 512. In various implementations, only the data used to filter the set of trades is obtained prior to the filtering module 508 and the additional data to calculate a liquidity factor and a leverage factor are obtained by one of the other modules of the recommendation generation module 112.

The liquidity factor determination module 512 computes the liquidity factor for the remaining set of trades using the liquidity factor calculation and parameters described above.

The liquidity factors are forwarded to a liquidity factor filtering module 516. The liquidity factor filtering module 516 removes trades with a liquidity factor above a threshold of, for example, 0.4. As described previously, the liquidity factor indicates how desirable the trade is or how frequently the trade is executed, and the lower the liquidity factor, the more likely the user would want to and be able to perform the trade.

The set of trades, now filtered, is forwarded to a leverage determination module 520. The leverage determination module 520 computes the leverage factor for each of the trades using the leverage factor equation described above. The set of trades is forwarded to a difference and sorting module 524 to determine a difference between the leverage factors of the trades and the requested leverage factor. The difference and sorting module 524 sorts the set of trades according to the difference in, for example, an ascending or descending order. The set of trades is then displayed as a recommendation list on the user device. By filtering the number of trades at multiple intervals throughout the generation of the recommendation list, the number of calculations performed is significantly reduced, increasing computational efficiency and improving user experience.

Optionally, the leverage determination module 520 can receive a rebalancing check request for a user portfolio. The rebalancing check request can be automatically generated according to user preferences selected upon account creation or subsequently when the user is indicated their desired leverage factor. The leverage determination module 520 then calculates the leverage factor of the financial instruments in the user portfolio. Based on an average of the leverage factors, the leverage determination module 520 can determine an overall leverage factor. The rebalancing check request may include a previously input leverage factor range that the user wants the leverage factor of the portfolio to maintain.

The leverage determination module 520 forwards the user portfolio leverage factor to an alert generation module 528 to generate an alert in response to the user portfolio leverage factor being outside of the previously input leverage factor range. The alert generation module 528 also optionally generates a leverage request for the portfolio using the previously input leverage factor range if an alert is generated. The generated leverage request is forwarded to the data gathering module 504 to generate a recommendation list. The automatically generated leverage request provides the user with automatic rebalancing when the user's portfolio has a leverage factor outside of the user's desired or input leverage factor range. In various implementations, the user may be alerted and presented with potential trades to rebalance the user's portfolio to realize the input leverage factor range.

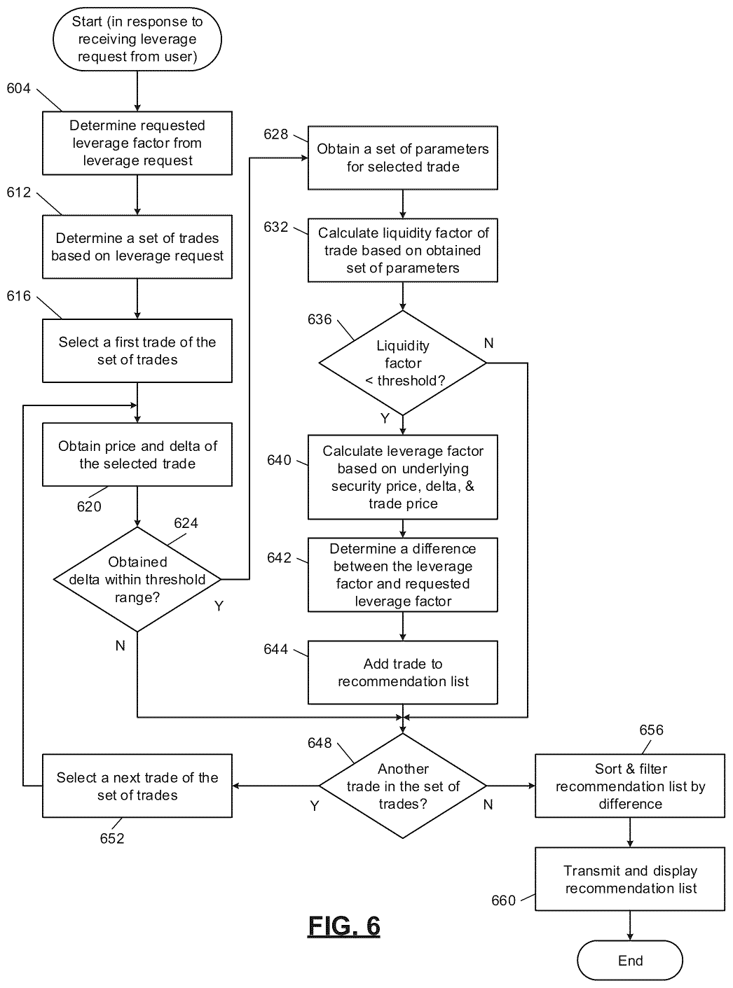

FIG. 6 is a flowchart depicting example generation of a recommendation list. Control begins in response to receiving a leverage request from a user using a user device. Control continues to 604 to determine a requested leverage factor from the leverage request. As described previously, the leverage request may include multiple variables to limit the trades included on in the generated recommendation list. Further, the leverage request may only be a request to generate a recommendation list and control determines the requested leverage factor as a default value or a present leverage factor of the user's portfolio. Control continues to 612.

At 612, control determines a set of trades based on the leverage request. In various implementations, control may optionally obtain the user's portfolio and only include trades associated with financial instruments included in the user's portfolio in the set of trades. Otherwise, the set of trades can be all available trades or include trades related to underlying securities included in the leverage request. Control continues to 616 to select a first trade of the set of trades. At 620, control obtains a price and a delta of the selected trade. Control proceeds to 624 to determine if the obtained delta is within a threshold range. As described above the threshold range may indicate that the trade corresponds to the stock market generally increasing, such as a range of 0 to 1.

If the delta is within the threshold range, control proceeds to 628 to obtain a set of parameters for the selected trade. Control continues to 632 to calculate a liquidity factor of the selected trade based on the obtained set of parameters. As described above the set of parameters obtained and used to calculated the liquidity factor may include: (i) a bid, (ii) an ask, (iii) a mark, (iv) a contract multiplier, (v) an open interest, and/or (vi) a volume. Control proceeds to 636 to determine if the liquidity factor is less than a threshold. The threshold may be, for example, 0.4. In various implementations, control may plot and determine a slope between each increasing liquidity factor. Then, once the slope begins to increase significantly (for example, double), control identifies the corresponding liquidity factor as the threshold.

If the liquidity factor is less than the threshold, control proceeds to 640 to calculate the leverage factor based on the underlying security price, the delta, and the trade price. Depending on the trade (long call, spread, etc.), the trade price may equal or correspond to the ask, the bid, the midpoint, theoretical price, etc. In various implementations, the underlying security price may be obtained at 628. Control continues to 642 to determine a difference between the leverage factor and the requested leverage factor. The difference indicates how close the trade is to the requested leverage factor. Control continues to 644 to add the trade to the recommendation list, including the calculated difference, liquidity factor, and leverage factor.

Control proceeds to 648 to determine if another trade is in the set of trades. Returning to 624 and 636, if the delta is not within the threshold range or the liquidity factor is above the threshold, respectively, control proceeds to 648 to determine if another trade is included in the set of trades. If yes, control proceeds to 652 to select a next trade of the set of trades and return to 620. Otherwise, control proceeds to 656 to sort and filter the recommendation list according to the difference. For example, the trade with the lowest difference would be sorted to the top. In various implementations, if the difference is greater than a threshold, such as 50% of the requested leverage factor, the trade may be removed. Control proceeds to 660 to transmit and display the recommendation list. Then, control ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct.” when a relationship between first and second elements is described in the above disclosure, that relationship encompasses a direct relationship where no other intervening elements are present between the first and second elements, and also an indirect relationship where one or more intervening elements are present (cither spatially or functionally) between the first and second elements. The phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A system comprising:
at least one processor; and
a memory coupled to the at least one processor,
wherein the memory stores:
a parameter database including a set of parameters for a plurality of entities; and
instructions for execution by the at least one processor; and
wherein the instructions include, in response to receiving a request control signal including a scaling factor from a user device:
obtaining a set of actions and a corresponding equivalence value for each action from the parameter database;
filtering the set of actions based on the corresponding equivalence value of the set of actions;
for each action of the filtered set of actions:
obtaining a set of parameters from the parameter database;
computing a recommendation factor based on the set of parameters; and
adding the corresponding action to a recommendation list in response to the recommendation factor being less than a threshold; and
transforming an interface of the user device by rendering a graphical depiction of the recommendation list.

2. The system of claim 1 wherein the instructions include, for each action of the recommendation list:
computing an action scaling factor; and
displaying the action scaling factor in the recommendation list.

3. The system of claim 2 wherein:
the action scaling factor is based on at least one of: (i) a change value, (ii) a parameter of a corresponding entity, and (iii) an amount of the action, and
the parameter of the corresponding entity corresponds to time-series data associated with the corresponding entity.

4. The system of claim 2 wherein the instructions include, for each action of the recommendation list:
calculating a difference between the corresponding action scaling factor and the scaling factor; and
displaying the corresponding difference in the recommendation list.

5. The system of claim 4 wherein the instructions include:
sorting the recommendation list based on the difference.

6. The system of claim 1 wherein:
the corresponding equivalence value is a delta value indicating a value of the corresponding action compared to a value of an entity, and
the entity is associated with the corresponding action.

7. The system of claim 1 wherein:
filtering the set of actions includes removing a first action from the set of actions when the corresponding equivalence value is negative and the scaling factor is positive.

8. The system of claim 1 wherein:
filtering the set of actions includes removing a first action from the set of actions when the corresponding equivalence value is positive and the scaling factor is negative.

9. The system of claim 1 wherein:
the request control signal includes an asset identifier; and
obtaining the set of actions includes obtaining each action associated with the asset identifier.

10. The system of claim 1 wherein the instructions include:
determining an output to realize the scaling factor; and
filtering the set of actions based on the output to realize the scaling factor.

11. The system of claim 10 wherein:
the request control signal includes the output to realize the scaling factor.

12. The system of claim 10 wherein:
the memory stores a user parameter database including account information of a user operating the user device, and
determining the output includes:
obtaining the account information of the user;
identifying the output based on the account information; and
excluding account information including an association with an entity.

13. A method comprising:
in response to receiving a request control signal including a scaling factor from a user device:
obtaining a set of actions and a corresponding equivalence value for each action from a parameter database, wherein the parameter database including a set of parameters for a plurality of entities;
filtering the set of actions based on the corresponding equivalence value of the set of actions;
for each action of the filtered set of actions:
obtaining a set of parameters from the parameter database;
computing a recommendation factor based on the set of parameters; and
adding the corresponding action to a recommendation list in response to the recommendation factor being less than a threshold; and
transforming an interface of the user device by rendering a graphical depiction of the recommendation list.

14. The method of claim 13 further comprising, for each action of the recommendation list:
computing an action scaling factor; and
displaying the action scaling factor in the recommendation list.

15. The method of claim 14 wherein:
the action scaling factor is based on at least one of: (i) a change value, (ii) a parameter of a corresponding entity, and (iii) an amount of the action, and
the parameter of the corresponding entity corresponds to time-series data associated with the corresponding entity.

16. The method of claim 14 further comprising, for each action of the recommendation list:
calculating a difference between the corresponding action scaling factor and the scaling factor; and
displaying the corresponding difference in the recommendation list.

17. The method of claim 16 further comprising:
sorting the recommendation list based on the difference.

18. The method of claim 13 wherein:
the corresponding equivalence value is a delta value indicating a value of the corresponding action compared to a value of an entity, and
the entity is associated with the corresponding action.

19. The method of claim 13 wherein:
filtering the set of actions includes removing a first action from the set of actions when the corresponding equivalence value is negative and the scaling factor is positive.

20. The method of claim 13 wherein:
filtering the set of actions includes removing a first action from the set of actions when the corresponding equivalence value is positive and the scaling factor is negative.
